(19) United States
(12) Patent Application Publication
(10) Pub. No.: US 2007/0120378 A1
(43) Pub. Date: May 31, 2007

(54) Door closing apparatus

(75) Inventors: Shigeru Hayakawa, Chiryu-shi (JP); Motohiro Kokubo, Kariya-shi (JP); Toshitsugu Oda, Okazaki-shi (JP); Tsutomu Kobayashi, Toyohashi-shi (JP); Nobuko Watanabe, Kariya-shi (JP)

Correspondence Address: BUCHANAN, INGERSOLL & ROONEY PC, POST OFFICE BOX 1404, ALEXANDRIA, VA, 22313-1404, US

(73) Assignee: Aisin Seiki Kabushiki Kaisha, Kariya-shi (JP)

(21) Appl. No.: 11/598,088

(22) Filed: Nov. 13, 2006

(30) Foreign Application Priority Data
Nov. 17, 2005 (JP) 2005-333263

(51) Int. Cl. E05C 3/06

(52) U.S. Cl. 292/216

(57) ABSTRACT

1. A door closing apparatus includes a latch mechanism operated for opening or closing a door of a vehicle, a driving mechanism transmitting a driving force to the latch mechanism to operate the latch mechanism, a first lever rotatably disposed about a first rotational axis and rotating in one direction in response to transmission of an operation force of a door handle to the first lever so that the latch mechanism is controlled at the unlatched state, a second lever having an engaging portion which engages with the first lever and rotatably disposed about a second rotational axis being different from the first rotational axis. The second lever rotates in the one direction about the second rotational axis in response to a rotation in the one direction of the first lever to interrupt transmission of the driving force from the driving mechanism to the latch mechanism.

### CROSS REFERENCE TO RELATED APPLICATIONS

This application is based on and claims priority under 35 U.S.C § 119 with respect to Japanese Patent Application 2005-333263, filed on Nov. 17, 2005, the entire content of which is incorporated herein by reference.

### FIELD OF THE INVENTION

The present invention relates to a door closing apparatus for a vehicle.

### BACKGROUND

Conventionally, a door closing apparatus transmits a driving force of an driving mechanism to a latch mechanism to operate the latch mechanism in a half latched state to a full latched state for closing a vehicle door at a half closed position to a full closed position. For example, the door closing apparatus disclosed in Japanese Patent 3315068 is known. In the door closing apparatus, an operational force is transmitted to an open lever and for rotating the open lever about an axis. Consequently, a latch mechanism is put into an unlatched state. Moreover, in response to the rotation of the open lever, a link mechanism swings to rotate a lever connected thereto via a wire and transmission of the driving force between the driving mechanism and the latch mechanism is blocked. Therefore, a closing operation of a vehicle door is halted and can be opened. The link mechanism is used for adjusting (or increasing) a rotational distance (stroke) of the lever relative to a rotational distance (stroke) of the open lever within an allowable range of the rotational distance (stroke) of the open lever for putting the latch mechanism into the unlatched state in order to block the transmission of the driving force from the driving mechanism to the latch mechanism.

According to Japanese Patent 3315068, blocking of the driving force between the driving mechanism and the latch mechanism, which associated with the rotation of the open lever, is conducted via multiple links. Thus, the increase in the number of parts and the increase of the production processes are unavoidable. In addition, in order to arrange these links, flexibility of an arrangement for an entire apparatus is restricted.

The present invention has been made in view of the above circumstances, and provides a door closing apparatus which is able to restrict the increase in the number of the components and the increase of the production processes.

### SUMMARY OF THE INVENTION

According to an aspect of the present invention, a door closing apparatus includes a latch mechanism operated for opening or closing a door of a vehicle, the latch mechanism being at a half latched state at a time that the door is half closed, the latch mechanism being at a full latched state at a time that the door is fully closed, and the latch mechanism being at an unlatched state at a time that the door is open, a driving mechanism transmitting a driving force to the latch mechanism to operate the latch mechanism, a first lever rotatably disposed about a first rotational axis and rotating in one direction about the first rotational axis in response to transmission of an operation force of a door handle to the first lever so that the latch mechanism is controlled at the unlatched state, a second lever having an engaging portion which engages with the first lever and rotatably disposed about a second rotational axis being different from the first rotational axis, the second lever rotating in the one direction about the second rotational axis in response to a rotation in the one direction of the first lever to interrupt transmission of the driving force from the driving mechanism to the latch mechanism.

### BRIEF DESCRIPTION OF THE DRAWINGS

The foregoing and additional features and characteristics of the present invention will become more apparent from the following detailed description considered with reference to the accompanying drawings, wherein:

FIG. 1 is an front view illustrating a vehicle door 1 to which the invention is applied;

FIG. 2 is a plain view illustrating a vehicle door;

FIG. 3 is a front view illustrating a door latch device;

FIG. 4 is a side view illustrating the door latch device;

FIG. 5 is a front view illustrating the door latch device;

FIG. 6 is a front view illustrating the door latch device;

FIG. 7 is a front view illustrating an actuator;

FIGS. 8 (a) and (b) are rear side views illustrating the actuator;

FIG. 9 is a cross sectional view taken from a line IX-IX of FIG. 8; and

FIG. 10 is a cross sectional view taken from a line X-X of FIG. 3.

### DETAILED DESCRIPTION

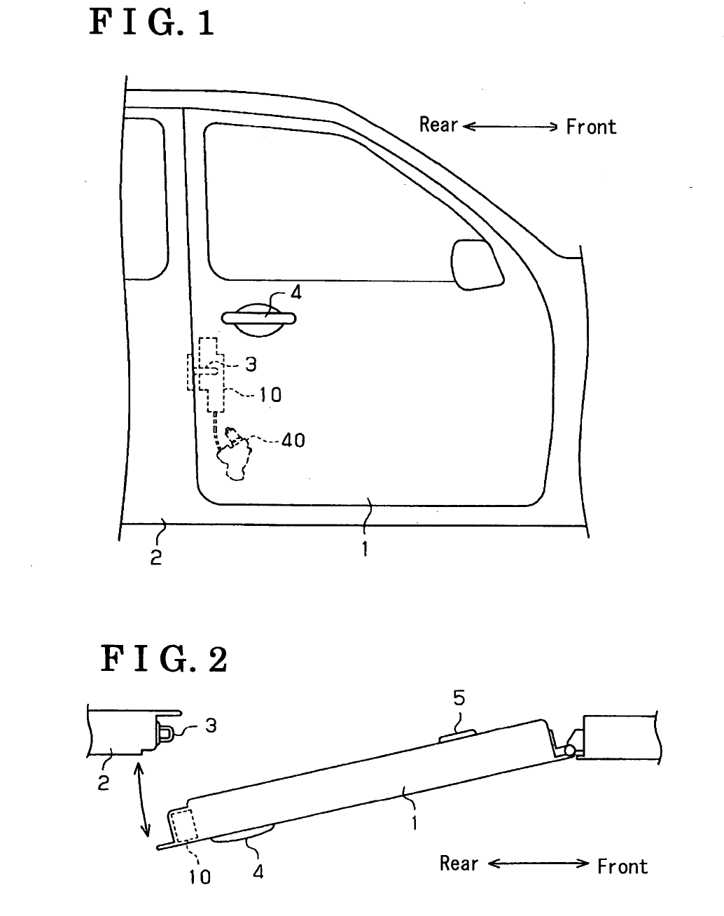

An embodiment of the present invention will be described below with reference to the attached drawings. FIG. 1 is a front view illustrating a vehicle door 1 to which the invention is applied and FIG. 2 is a plain view thereof. As illustrated in FIG. 2, the vehicle door 1 is a so called swing type door which is hinged to a vehicle body 2 (a main body of the vehicle) to open and close a door opening. A door latch device 10 is mounted at an end portion of a vehicle rear side. The door latch device 10 holds the vehicle door 1 in a half closed state or a full closed state by engaging with a U shaped type striker 3. The striker 3 is fixed to the vehicle body 2 side. The door latch device 10 is connected to an outside door handle 4 and an inside door handle 5 which are respectively disposed inside and an outside of the vehicle door 1. An operational force is transmitted from either the door handle 4 or the door handle 5 and an engagement with the striker 3 is released to allow the vehicle door 1 to be openable.

Further, the door latch device 10 is connected to an actuator 40 which is a driving mechanism mounted in the vehicle door 1. When the driving force of the actuator 40 is transmitted, the door latch device 10 is engaged with the striker 3 so that the vehicle door 1 in the half closed state is operated to be in the full closed state. The actuator 40 is operatively connected to the door handle 4 and the door handle 5. The operational force is transmitted from either the door handle 4 or the door handle 5 to block the transmission of the driving force to the latch mechanism 10.

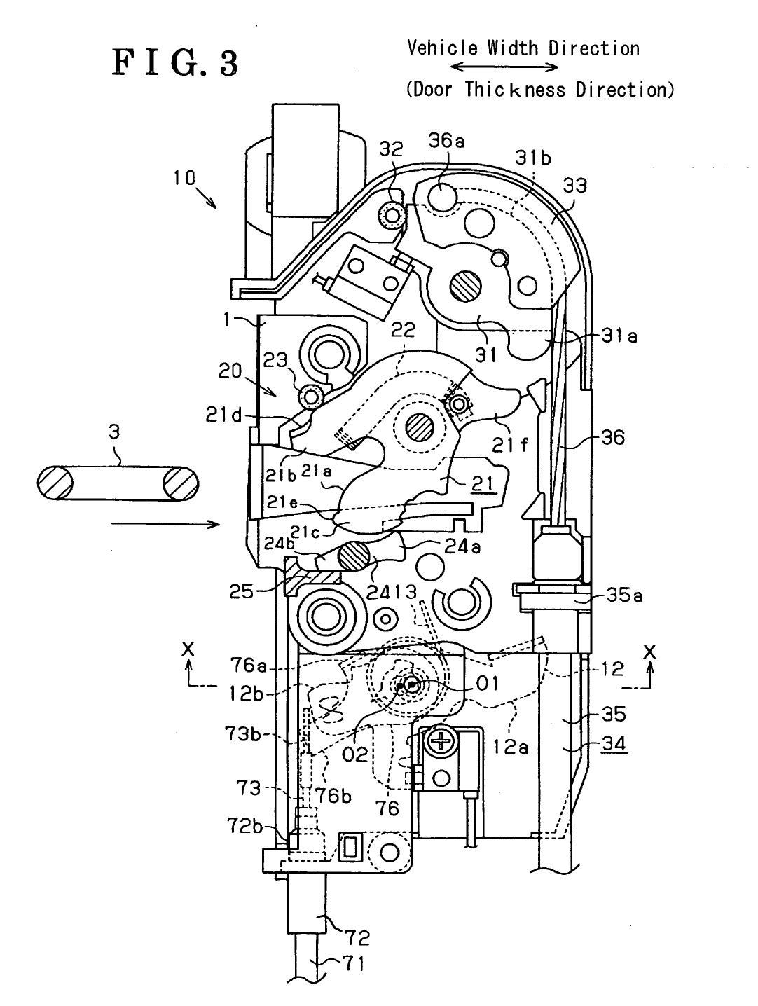

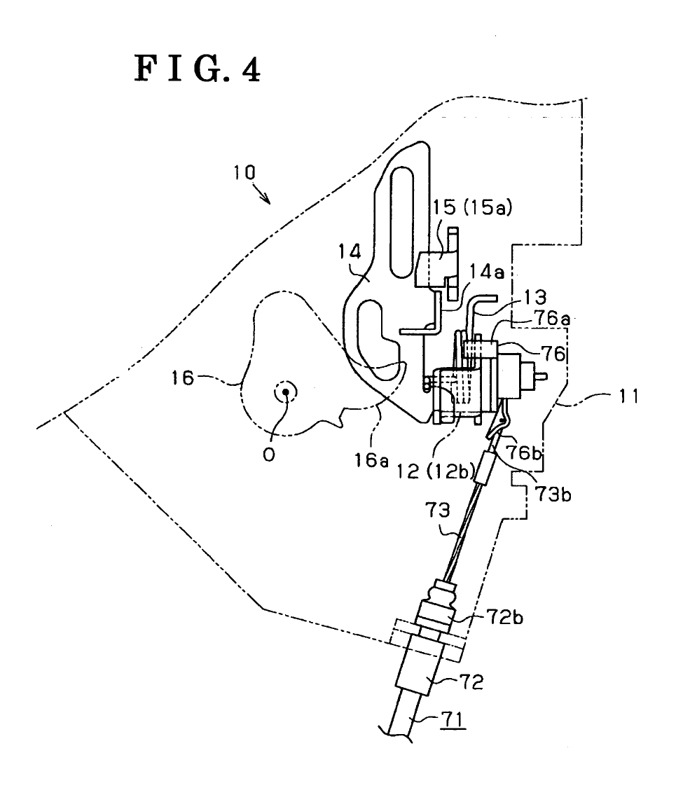

Secondly, a structure of the door latch device 10 will be described with reference to FIG. 3 to FIG. 6. FIG. 3 is a front view and FIG. 4 is a side view of the door latch device 10. These figures respectively correspond to a view viewed from a rear side of the vehicle and a view viewed from an inside of a vehicle in a width direction. As illustrated in the figures, a main body portion 11 forms an outer profile of the door latch devise 10, and houses or supports various components therein. In the main body portion 11, an open lever 12, which is a first lever member made of a plate material, is rotatably supported around a first rotational axis 01. The open lever 12 is supported in a predetermined rotational position with the open lever 12 being biased by a torsion spring 13 coiled around the first rotational axis 01. The open lever 12 is connected to the outside door handle 4 via a known coupling member at an end portion 12a located on one side of the open lever 12 (the right side of FIG. 3). The operational force of the outside door handle 4 is transmitted to rotate the open lever 12 in a clockwise direction in the figure against the torsion spring 13 to raise an end portion 12b positioned on the other side of the open lever 12. (the left side of FIG. 3) When the operational force of the outside door handle 4 is released, the open lever 12 is biased by the torsion spring 13 to rotate in a counterclockwise direction and lower the end portion 12b. Thus, the open lever 12 returns to the predetermined rotational position

As illustrated in FIG. 4, in the end portion 12b of the open lever 12, a lower end of an open link 14 is supported for swing the open link 14. In addition, an L shaped flange 14a formed in an intermediate portion of the open link 14 in a horizontal direction is arranged in a way that the flange 14a can face a tip portion 15a of a lift lever 15 from a lower side. The lift lever 15 is formed by a plate material which is rotatably supported by the main body portion 11.

Furthermore, an inside open lever 16, which is made of a plate material, is supported by the main body portion 11 in the state that the inside open lever 16 can rotate on a rotational axis 0. A tip portion 16a of the inside open lever 16 extends to a radially outer side of the open lever 16 and is arranged in a way that the tip portion 16a can face the flange 14a from a lower side. Moreover, the inside open lever 16 is connected to the inside door handle 5 via a known coupling member and the operational force of the inside door handle 5 is transmitted. The inside open lever 16 rotates in a counterclockwise direction in the figure to raise the tip portion 16a. When, the operational force of the inside open lever 16 is released, the inside open lever 16 rotates in a clockwise direction in the figure to lower the tip portion 16a. The inside open lever 16 is biased up to an initial position of the open link 14 by the torsion spring 13. The inside open lever 16 is then biased up to an initial position by the operation of the inside door handle 5 and returns to a predetermined rotational position.

As illustrated in FIG. 3, in the main body portion 11, a latch 21 is rotatably supported at the upper side of the open lever 12 and formed in a U shape having an engaging recessed portion 21a. The latch 21 is formed with a first detent portion 21b and a second detent portion 21c. The first detent portion 21b is formed on one side (the side in a clockwise direction of FIG. 3) and the second detent portion 21c are formed on the other side (the side in the counterclockwise direction of FIG. 3) with respect to the engaging recessed portion 21a. In a tip portion of the first detent portion 21b, a first engaging portion 21d is formed on the latch 21 at an opposite side of the engaging recessed portion 21a. In a tip portion of the second detent portion 21c, a second engaging portion 21e is formed on the latch 21 at the engaging recessed portion 21a side. The latch 21 is further formed with a projecting follower 21f extending toward the opposite side of the engaging recessed portion 21a relative to a rotational axis. One end of the latch biasing spring 22, which is held to the main body portion 11 at the other end, engages with the latch 21. Subsequently, the latch 21 is biased in a direction where the latch 21 rotates in a clockwise direction. An opposing surface of the first detent portion 21b engages with a latch stopper 23 located in the main body portion 11. Thus, the rotation in the clockwise direction is restricted and the latch 21 is held in a predetermined position.

Additionally, in the main body portion 11, a pawl 24 is rotatably supported between the open lever 12 and the latch 21. The pawl 24 is connected to the lift lever 15 so that the pawl 24 can unitary rotate with the lift lever 15. The pawl 24 is formed with an engaging end portion 24a and an extending end portion 24b. The engaging end portion 24a extends to one side (the left side of FIG. 3) and the extending end portion 24b (right side of FIG. 3) extends to the other side relative to a rotational axis. One end of a pawl biasing spring (not shown in the figure), which is held to the main body portion 11 at the other side, engages with the pawl 24. Thus, the pawl 24 is biased in a counterclockwise direction in where the pawl 24 rotates, namely, the direction where the engaging 24a is raised. An opposing surface of the extending end portion 24b contacts a pawl stopper 25 located in the main body portion 11 and the rotation in the counterclockwise direction is adjusted to hold the pawl 24 in a predetermined position. The pawl 24 forms a latch mechanism 20 along with the latch 21 and other components.

A basic operation of the latch mechanism 20 will be explained. In the state that the vehicle door 1 opens, as illustrated in FIG. 3, the opposing surface of the first detent portion 21b contacts the latch stopper 23. Thus, the latch 21 is held at the predetermined rotational position and the engaging recessed portion 21a opens to an insertion passage of the striker 3 for closing operation of the vehicle door 1. The opposing surface of the extending end portion 24b contacts the pawl stopper 25. Thus, the pawl 24 is rotatably held at the predetermined position and the engaging end portion 24a is arranged at the lower side of the second detent portion 21c. This operation state of the latch mechanism 20 is referred to as an unlatched state.

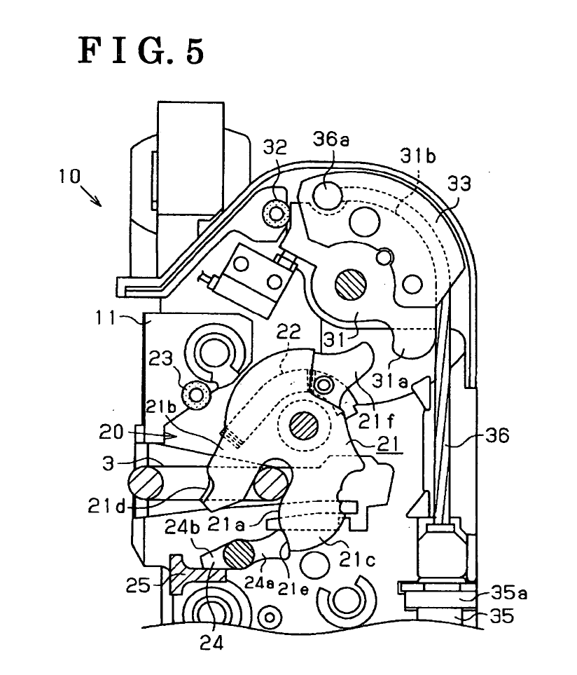

Secondly, in response to the closing operation of the vehicle door 1, the striker 3 is inserted into the engaging recessed portion 21a, an inner wall surface of the engaging recessed portion 21a is pressed by the striker 3. As illustrated in FIG. 5, the latch 21 rotates in a counterclockwise direction of the figure against the latch biasing spring 22 and the rotation is stopped by the engagement of the second engaging portion 21e with the engaging end portion 24a. At this moment, the vehicle door 1 is in a half closed state wherein the vehicle door 1 engages with the striker 3 at the engaging recessed portion 21a to prevent the striker 3 from disengagement with the vehicle door 1. The latch mechanism 20 in this state is referred to as a half latched state.

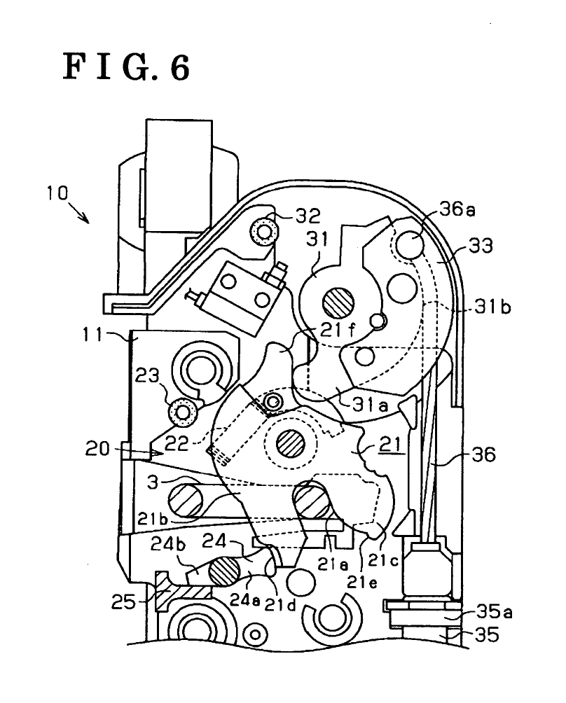

Subsequently, in response to further operation for closing the vehicle door 1, the striker 3 moves into the insertion passage, the inner wall of the engaging recessed portion 21a is pressed by the striker 3. Consequently, as illustrated in FIG. 6, the latch 21 further rotates in the counterclockwise direction of the figure against the latch biasing spring 22 and the rotation is stopped by the engagement of the first engaging portion 21d with the engaging end portion 24a. In this moment, the vehicle door 1 is in a full closed state wherein the vehicle door 1 engages with the striker 3 at the engaging recessed portion 21a to prevent the striker 3 from disengagement with the vehicle door 1. The latch mechanism 20 in this state is referred to as a full latched state.

Furthermore, in the half latched state or the full latched state described above, when the pawl 24 rotates in the clockwise direction in the figure against the pawl biasing spring, the engagement of the engaging end portion 24a with either the first engaging portion 21d or the second engaging portion 21e is released. At this moment, the latch 21 is biased by the latch biasing spring 22 and rotates in the clockwise direction pressing the striker 3 by the inner wall of the engaging recessed portion 21a. Then, the vehicle door 1 is disengaged with the striker 3 at the engaging recessed portion 21a and becomes openable.

As illustrated in FIG. 3, in the main body portion 11, an operational lever 31 is rotatably supported by the main body portion 11 at the upper side of the latch 21. A driving projecting portion 31a extending toward one side (the lower side in FIG. 3) is formed in the operational lever 31. One end of the lever biasing spring (not shown in the figure) is supported by the main body portion 11 and the operational lever 31 is engaged with the other end of the lever biasing spring. Thus, the operational lever 31 is biased in a direction where the operational lever 31 rotates in a counterclockwise direction. A rotation of the operational lever 31 in the counterclockwise direction is restricted by contacting a lever stopper 32 located in the main body portion 11 to hold the operational lever 31 in a predetermined position. The driving projecting portion 31a is positioned so that the projecting follower 21f is arranged on a rotational path of the operational lever 31 (Refer to FIG. 5) when the latch mechanism 20 is in the half latched state.

The operational lever 31 is further formed with an arc-shaped guide surface 31b at an upper side of the rotational axis, and two guide plates 33 (only one plate is illustrated in FIG. 3) made of a plate material are secured to the operational lever 31 with the guide plates 33 sandwiching the guide surface 31b. In the main body portion 11, an end portion 35a of an outer tube 35 forming a driving cable 34 is held at the lower side of the operational lever 31. These guide plates 33 secure an end 36a of a driving wire 36 which is pulled from the end portion 35a to be guided to the guide surface 31b. Therefore, when the driving wire 36 is pulled into the end portion 35a, the operational lever 31 to which the guide plates 33 are secured rotates in a clockwise direction of the figure against the lever biasing spring. The driving wire 36 (the driving cable 34) is connected to the actuator 40. When the driving force of the actuator 40 is transmitted, the driving wire 36 is pulled into the end portion 35a so that the operational lever 31 rotates in the clockwise direction of the figure.

In the half latched state of the latch mechanism 20 illustrated in FIG. 5, when the driving ware 36 is pulled, the operational lever 31 rotates in the clockwise direction of the figure. The operational lever 31 then presses the projecting follower 21f of the latch 21 at the driving projecting portion 31a. Thus, the latch 21 rotates in a counterclockwise direction in the figure against the latch biasing spring 22. Consequently, the striker 3 which engages with the engaging recessed portion 21a is pulled to bring the latch mechanism 20 into the full latch state. At this moment, the vehicle door 1 performs the closing operation from the half closed state to the fill closed state.

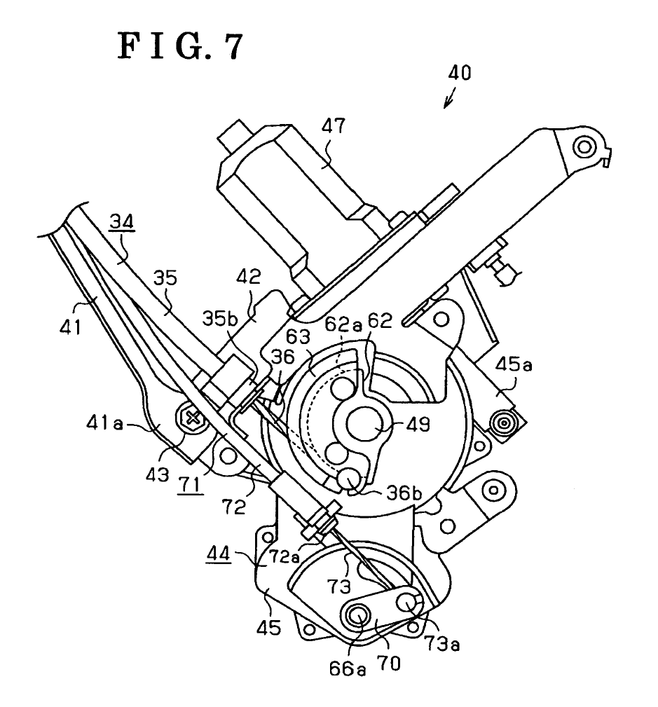

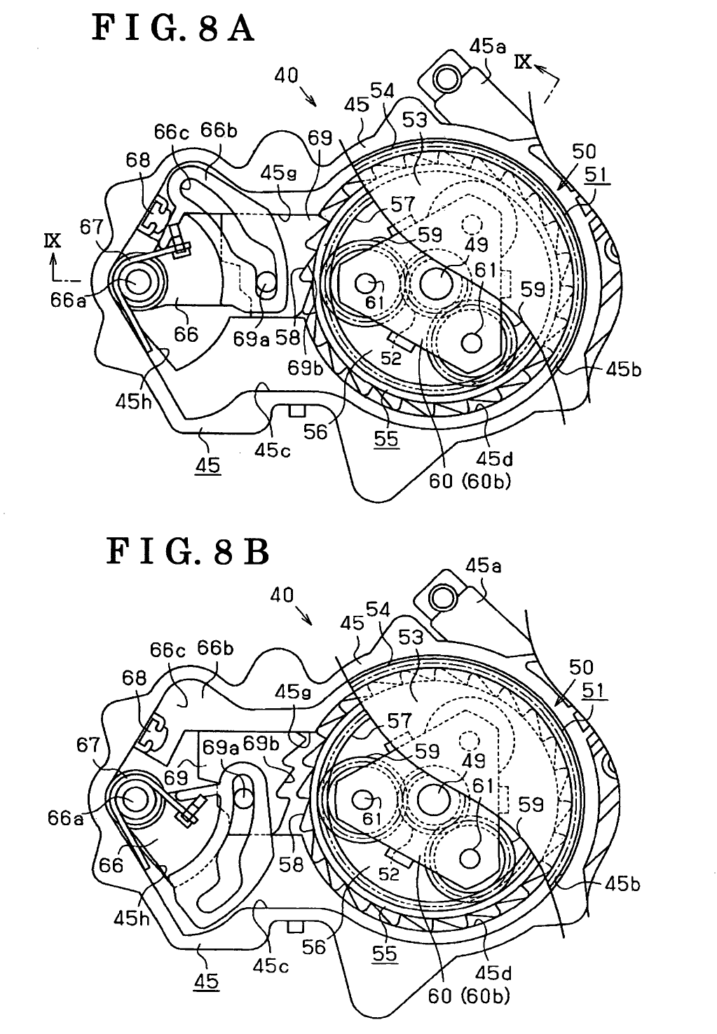

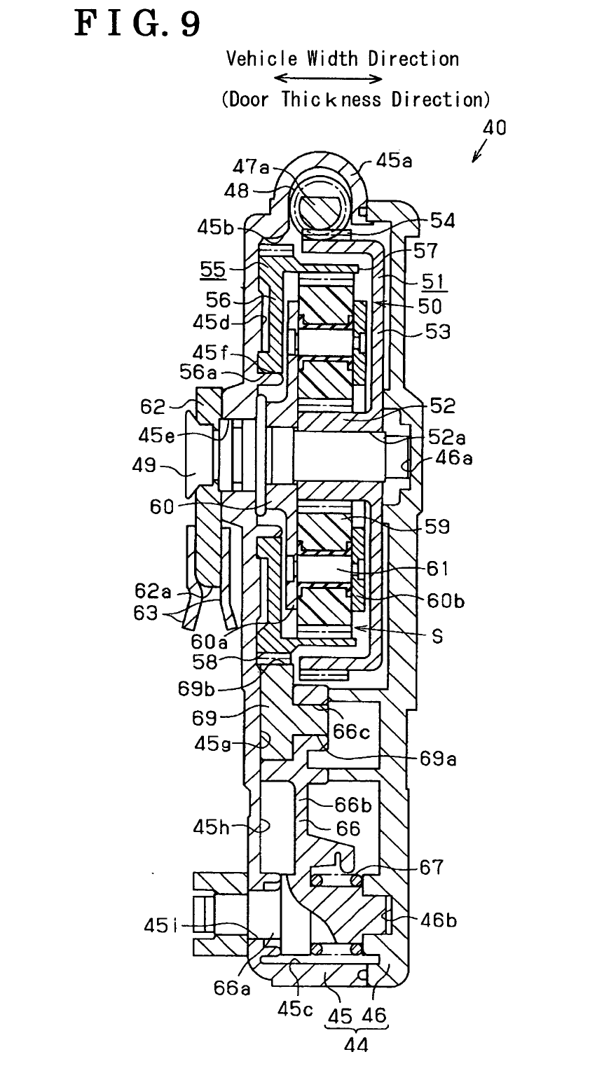

Next, a structure of the actuator 40 will be described with reference to FIG. 7 to FIG. 9. FIG. 7 is a front view of the actuator 40 and viewed from the outer side in a vehicle width direction illustrating how the actuator 40 is arranged. FIG. 8 is a rear side view of the actuator 40 and FIG. 9 is a cross sectional view taken along a line IX-IX of FIG. 8. As illustrated in FIG. 7, a bracket 41 formed in an elongated shape by a plate material at an end portion 41a of the bracket 41 is connected to a support bracket 42 with a screw 43. The other end of the bracket 41 is fixed to the main body portion 11 of the latch device 10 by a fastening means. (Not shown in the figure) The actuator 40 is secured to and supported by the door latch device 10 by fastening a box shaped housing 44 to the support bracket 42 via the bracket 41. The housing 44 forms an outer shape of the actuator 40 and houses and supports various components of the actuator 40. As illustrated in FIG. 9, the housing 44 has a cup shaped case 45 and a cover 46. The case 45 defines a housing space for the various components and the cover 46 blocks an opening of the case 45.

As illustrated in FIG. 7 and FIG. 9, the case 45 extends an axis in one direction (the right lower direction of FIG. 7) at one end portion (the right upper side of FIG. 7) and is formed with a cylindrical worm encasement 45a which partially opens to the housing space side. (the lower side of FIG. 9) In the worm encasement 45a, a worm 48 is rotatably housed. The worm 48 is secured to a rotational shaft 47a (Refer to FIG. 9) of an electric motor 47 fixed to the case 45 by fastening. The electric motor 47 is driven and controlled by a controller (not illustrated) to rotate the rotational shaft 47a (worm 48) in a normal direction or a reversing direction

As illustrated in FIG. 8 and FIG. 9, the case 45 is formed with a gear encasement 45b having a cup shape cylindrical form by cutting a part of cylindrical portion of the worm encasement 45a. The gear encasement 45b is molded so that one side of the cylindrical form in a radial direction (the left side of FIG. 8) opens. The case 45 is further formed with an encasement 45c formed in a polygonal cup shape in a manner that the encasement 45c is continuous with the opening side of the gear encasement 45b (the left side of FIG. 8). In other words, a bottom wall of the case 45 presents in a combination of circular and polygonal shapes.

The gear encasement 45b is formed with a recessed portion 45d which has a smaller internal diameter than an internal diameter of the gear encasement 45b and is roundly recessed from the bottom wall. The gear encasement 45 is further formed with a bearing hole 45e in a central portion of the bottom wall (Refer to FIG. 9). One end of an output shaft 49 whose axial line extends along a central line of the encasement 45 is rotatably inserted into the bearing hole 45e and a tip portion of the output shaft 49 is projected outward from the case 45 (the housing 44). The other end of the output shaft 49 is rotatably supported on a recessed portion 46a which is formed on the cover 46 and immovably supported to one side in an axial direction. (The right side of FIG. 9)

In the gear encasement 45b, a sun gear 51 is housed on the side where the cover 46 is positioned. The sun gear 51 is formed with a cylindrical sun gear portion 52 having an internal diameter which is equivalent to an external diameter of the output shaft 49 and a disc shaped flange 53 extending radially outward at one end of the sun gear portion 52 in the axial direction (the right side of FIG. 9). The sun gear 51 is further formed with a cylindrical worm wheel portion 54 extending from a peripheral portion of the flange 53 to the other side in the axial direction (the left side of FIG. 9) to fit into the worm 48. The sun gear 51 forms a box shaped portion by the sun gear portion 52, the flange portion 53 and the worm wheel portion 54 and defines an annular housing space S. An inner circumference of the sun gear 52 is formed with a bearing hole 52a into which the output shaft 49 is fitted so as to allow relative rotation therebetween. The sun gear portion 52 is formed so that the axial position of the sun gear portion 52 lays over the axial position of the worm wheel portion 54.

The recessed portion 45d is formed with a projecting wall 45f having a common axis with the bearing hole 45e and projecting in a cylindrical form to the direction where the cover 46 is positioned and a ring gear 55 is rotatably supported in the projecting wall 45f The ring gear 55 has an external diameter which is smaller than each internal diameter of the worm wheel 54 and the recessed portion 45d and is formed in a cup shape. The ring gear 55 is formed with an annular bottom wall portion 56 having a bearing hole 56a into which the projecting wall portion 45f is inserted and a cylindrical ring gear portion 57 extending from an peripheral portion of the bottom wall portion 56 to one side in the axial direction (the right side of FIG. 9). The ring gear portion 57 is disposed in a way that the axial position of the ring gear portion 57 lays over the axial position of the sun gear portion 52 with the tip portion of the ring gear portion 57 housed in the housing space S. Further, a plurality of engaging detents 58 is formed on a proximal side which is not aligned with the axial position of the worm wheel portion 54. The engaging detents 58 are formed in a predetermined pitch over an entire circumference in a circumference surface of the ring gear portion 57.

Multiple (Three) planet gears 59 are disposed at each predetermined angle between the sun gear portion 52 and the ring gear portion 57. Each planet 59 gear engages with the sun gear portion 52 and the ring gear portion 57. It is obvious that the planet gears 59 should be arranged so that the position in an axial direction of each planet gear 59, the position in an axial direction of the sun gear portion 52 and the position in an axial direction of the ring gear portion 57 overlap each other. A carrier 60 is secured to the output shaft 49 in the axial position which the output shaft 49 slidably contacts a tip portion of the sun gear portion 52. Each planet gear 59 is sandwiched by plates 60a and 60b forming the carrier 60 from both sides in an axial direction. Each supporting shaft 61 is held to each plate 60a at one end and is held to each plate 60b at the other end. Each supporting shaft 61 is fitted into each planet gear in the axial direction. Thus, each planet gear 59 is rotatably supported around the supporting shaft 61. Therefore, each planet gear 59 can rotate about the supporting shaft 61. In response to the rotation, the planet gear 59 revolves around the output shaft 49 along the ring gear portion 57. At the time, the carrier 60 unitary rotates with the output shaft 49.

A planet gear mechanism 50 is formed by the sun gear 51 (the sun gear portion 52), the ring gear 55 (the ring gear portion 57), the planet gears 59 and the carrier 60. As illustrated in FIG. 7, a segment-shaped driving lever 62 made of a plate material is fixed to the tip portion of the output shaft 49 extending outward from the housing 44 and an arc-shaped guide surface 62a is formed on the driving lever 62. Additionally, two guide plates 63 (one plate is shown in FIG. 7) are secured to the driving lever 62 with the guide plates 63 sandwiching the guide surface 62a. An end portion 35b of the outer tube 35 forming the driving cable 34 is supported by the support bracket 42 on one side of the driving lever 62. (the left side of the FIG. 7) These guide plates 63 support another end 36b of the driving wire 36 which is pulled from the end portion 35b and guided by the guide surface 62a. Therefore, when the driving lever 62 rotates in one direction (the counterclockwise direction of FIG. 7) along with the output shaft 49, the driving wire 36 is pulled from the end portion 35b. At this time, it is obvious that the driving wire 36 which is held on a side where the operational lever 31 is located is pulled into the end portion 35a. In other words, the driving lever 62 forms a power transmitting means along with the driving cable 34, the operational lever 31 and other components.

The encasement 45c is formed with a guide groove 45g which is continuous with one side of the recessed portion 45d in a radial direction (the left side of FIG. 8) and extends in a rectangular form along the direction. The encasement 45c is further formed with a lever side recessed portion 45h which is segment-shaped and continuous with a tip portion of the guide groove 45g. As illustrated in FIG. 9, the lever side recessed portion 45h is formed with a bearing hole 45i in the central portion of the segment-shape. One end of a lever shaft 66a which is integrally formed in a cancel lever 66 is rotatably inserted into the bearing hole 45i and the tip portion projects outward from the case 45 (the housing 44). The other end of the lever shaft 66a is rotatably supported by the recessed portion 46b formed on the cover 46 in a way that the lever shaft 66a cannot move to one side in the axial direction (the right side of FIG. 9) Moreover, the cancel lever 66 is formed with a segment-shaped lever 66b extending toward the guide groove 45g at the upper side the guide groove 45g avoiding interference with the guide groove 45g and an elongated cam hole 66c is formed in a tip portion of the lever portion 66b. The cam hole 66c is bent so that one side of the cam hole 66c (the counterclockwise direction) is disposed on the side where the lever shaft 66a is positioned relative to the other side of the cam hole 66c in a circumferential direction (the clockwise direction of FIG. 8)

A lever biasing spring 67 is coiled around the lever shaft 66a with one end of the lever biasing spring 67 supported by an inner wall surface located in one side of the encasement 45c (the clockwise direction of FIG. 8). The other end of the lever biasing spring 67 is engaged with the cancel lever 66, and the cancel lever 66 is biased in a counterclockwise direction in the figure. Further, an opposing surface of the lever portion 66b contacts a lever stopper 68, which is located in an inner wall of the other side of the encasement 45c (the counterclockwise direction of FIG. 8), and the rotation in the direction is restricted to hold the cancel lever 66 in a predetermined position.

A plate shaped cancel gear 69 is mounted in the guide groove 45g with the cancel gear 69 being movably in a radial direction of the recessed portion 45d arranged along the guide groove 45g. The cancel gear 69 is formed with an engaging pin 69a projecting in one direction (the front side positioned in a direction perpendicular to the paper of FIG. 8) to be inserted into the cam hole 66c and a plurality of gear side engaging detents 69b which is engageable with the engaging detents 58 in a tip portion of the recessed portion 45d. The engaging detents 58 face the guide groove 45g. As illustrated in FIG. 8 (a), in the state that the opposing face of the lever portion 66b contacts the lever stopper 68 and the cancel lever 66 is held in the predetermined position, the engaging pin 69a is pressed against an inner wall of the cam hole 66c, and the cancel lever 69 is forced out to the direction where the recessed portion 45d is located. Consequently, the gear side engaging detents 69b mesh the engaging detents 58 of the ring gear 55. At this moment, the ring gear 55 is engaged immovably. Meanwhile, as illustrated in FIG. 8 (b), in the state that the cancel lever 66 rotates in a clockwise direction of the figure against the lever biasing spring 67, the engaging pin 69a is pressed against the inner wall of the cam hole 66c, and the cancel lever 69 is pulled back to the side where the lever shaft portion 66a is positioned. Consequently, an engagement of the ring gear 55 with the engaging detents 58 is released. At this moment, the ring gear 55 becomes rotatable.

As illustrated in FIG. 7, a lever 70 which is made of a plate material is secured to a tip portion of the lever shaft portion 66a extending outward from the housing 44 (the case 45). In the housing 44, an end portion 72a of an outer tube 72 forming a cancel cable 71 is held at the upper side of the lever 70 and the lever 70 holds an end 73a of a wire 73 pulled from the end portion 72a. Therefore, when the wire 73 is pulled into the end portion 72a, the lever 70 rotates in a counterclockwise direction of the figure (the clockwise direction of FIG. 8) against the lever biasing spring 67 along with the cancel lever 66. The operational force of the door handle 4 and the door handle 5 is transmitted. Thus, the wire 73 (the cancel cable 71) is pulled into the end portion 72a so that the lever 70 rotates in the counterclockwise direction in the figure.

An operation of the actuator 40 will be described here. In the state that the ring gear 55 is immovably engaged by meshing between the engaging detents 58 and the gear side engaging detents 69b, the electrical motor 47 is driven and a rotational power in one direction (the clockwise direction of FIG. 8) is transmitted to the sun gear 51 (the worm wheel portion 54) meshing with the worm 48. The worm 48 is secured to the rotational shaft 47a. In response to the transmission of the rotational power, the sun gear portion 52 rotates in the direction. Thus, the planet gears 59 rotate on its axis in the other direction (the counterclockwise direction of FIG. 8) relative to the ring gear 55 and revolve in one direction (the clockwise direction of FIG. 8). The carrier 60 (the output shaft 49) outputs a rotational power in one direction (tie clockwise direction of FIG. 8). In other words, the planet gear mechanism 50 forms a speed reducer. In the speed reducer, the sun gear 51 serves as an input shaft, the ring gear 55 serves as a fixed shaft, and the carrier 60 serves as an output shaft. In the situation, in response to the rotation of the output shaft 49, the driving lever 62 rotates in a counterclockwise direction in FIG. 7, and the driving wire 36 is pulled from the end portion 35b. The ring gear 55 receives a reaction force caused by the rotation of the carrier 60 and attempts to rotate in the other direction (the counterclockwise direction in FIG. 8), the cancel gear 69 rigidly restricts the rotation of the ring gear 55 in the direction.

Meanwhile, in the state that the engagement between the engaging detents 58 and the gear side engaging detents 69b is released and accordingly, the ring gear 55 becomes movable, the transmission of the output rotational power which is from the carrier 60 (the output shaft) is stopped. Due to large load occurred on the output shaft 49 side, the rotational power transmitted from the sun gear 51 to each planet gear 59 can rotate only the ring gear 55. Thus, each planet gear stops the revolution and the carrier 60 stops rotating. As a result, the transmission of the output rotational power is stopped.

As illustrated in FIG. 3, a cancel lever 76 is made of a plate material and served as a second lever member. The cancel lever 76 is rotatably supported around the second rotational axis 02 in the main body portion 11. The second rotational axis is eccentrically disposed in one side (the left side of FIG. 3) of the first rotational axis 01. The cancel lever 76 is eccentrically disposed in one side of the open lever 12 in an axial direction. (the front side positioned in a direction perpendicular to the paper of FIG. 3), and is formed with a cam portion 76 served as an engaging portion. The cam portion 76 is a cam plate and bends to the other side of the open lever 12 (the back side positioned in the direction perpendicular to the paper of FIG. 3) at the upper side of the end portion 12b so as to be disposed on a rotational path of the open lever 12. In other words, the cam portion 76a is projected to interrupt the rotational path of the open lever 12. The open lever 12 rotates in the clockwise direction in the figure about the first rotational axis 01. The cam portion 76a is then pressed and slidably contacted by a contact surface of the end portion 12b. Hence, the cancel lever 76 rotates about the second rotational axis 02 in the clockwise direction. In the state that the open lever 12 is held in the predetermined rotational position, which is illustrated in FIG. 3, the cam portion 76a is engaged with the end portion 12b of the open lever 12, and the cancel lever 76 is held in a predetermined rotational position around the second rotational axis 02. The cancel lever 76 is formed with a mounting strip 76b extending in one direction (the left side of FIG. 3) and raises the mounting strip 76b by rotating in a clockwise direction in the figure about the second rotational axis 02.

In the main body portion 11, an end portion 72b of the outer tube 72 forming the cancel cable 71 is held at the lower side of the cancel lever 76. (the mounting strip 76b) The mounting strip 76b holds an end portion 73b of the wire 73 pulled from the end portion 72b. Therefore, when the cancel lever 76 rotates in the clockwise direction in the figure about the second rotational axis 02, the wire 73 is pulled from the end portion 72b. At that time, it is obvious that the wire 73 held on a side where the lever 70 is located is pulled into the end portion 72a. Thus, the cancel lever 66 rotates against the lever biasing spring 67, and the engagement of the gear side engaging detents 69b of the cancel gear 69 with the engaging detents 58 of the ring gear 55 is released to make the ring gear 55 rotatable. Even when either the door handle 4 or the door handle 5 is operated to open the door, the operational force is transmitted so as to raise the mounting strip 76b via the open lever 12. Hence, the ring gear 55 becomes rotatable and the output of the rotational power from the carrier 60 (the output shaft 49) is stopped. In other words, the cancel lever 76 forms a releasing means along with the cancel lever 66, the lever 70, the cancel cable 71 and other components. The reason that the ring gear 55 and the cancel lever 76 involving in the engagement and the disengagement of the cancel gear 69 is separated from the open lever to form different components is for avoiding influence on a return operation of the open lever 12, namely, return operations of the door handle 4 and the door handle 5 when a return operation of the cancel lever 76 is not performed properly. Furthermore, the reason that the rotational axis of the open lever 76 is eccentrically disposed relative to the rotational axis of the open lever 12 is for adjusting (increasing) the rotational distance (stroke) of the cancel lever 76 based on a predetermined allowable rotational distance of the open lever 12.

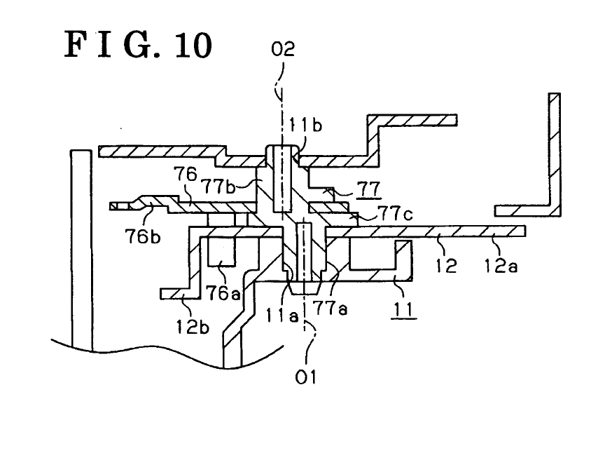

Supporting forms of the open lever 12 and the cancel lever 76 according to the embodiment will be described here. FIG. 10 is a cross sectional view taken along a line X-X of FIG. 3. As illustrated in the figure, a mounting hole 11a and a mounting hole 11b are formed in the main body portion 11. The mounting hole 11a has a common axis with the first rotational axis 01 and the mounting hole 11b has a common axis with the second rotational axis 02. The mounting holes 11a and 11b are roundly penetrated. A fist axial portion 77a of a snap 77 served as a supporting member is pressed into and supported by the mounting hole 11a and a second axial portion 77b of the snap 77 is pressed into and supported by the mounting hole 11b. It is obvious that the first axial portion 77a should be disposed so as to have a common axis with the first rotational axis 01 and the second axial portion 77b should be disposed so as to have a common axis with the second rotational axis 02. The snap 77 is formed with a flange 77c extending radially outward at a boundary portion between the first axial portion 77a and the second axial portion 77b.

The open lever 12 is penetrated by the fist axial portion 77a in a way that the open lever 12 is contacted by an end surface on a first axial portion 77a side of the flange 77c. The open lever 12 is rotatably supported around the first axial portion 77a in a way that the open lever 12 cannot move in an axial direction. The cancel lever 76 is penetrated by the second axial portion 77b in away that the cancel lever 76 is contacted by an end surface on a second axial portion 77b side of the flange 77c. The cancel lever 76 is rotatably supported around the second axial portion in a way that the cancel lever 76 cannot move in the axial direction. Therefore, the open lever 12 and the cancel lever 76 are rotatably supported around the respective rotational axes.

Next, an operation according to the embodiment will be generally described. In the state that the vehicle door 1 is in the half closed state or the full closed state and the latch mechanism 20 is in the half latched state illustrated in FIG. 5 or the full latched state illustrated in FIG. 6, when the outside door handle 4 is operated to open the vehicle door 1, the operational force is transmitted to the open lever 12. Thus, the open lever 12 rotates in the clockwise direction in FIG. 3 about the first rotational axis 01 to raise the end portion 12b. In the response to raising the end portion 12b, the open link 14 illustrated in FIG. 4 is raised. Consequently, the tip portion 15a of the lift lever 15 is pressed by the flange 14a of the open link 14 from the lower side. Thus, the lift lever 15 rotates and the pawl 24 unitary rotates with the lift lever 15 in the clockwise direction in FIG. 5 and FIG. 6, and the engagement of the engaging end portion 24a with the first engaging portion 21d or the second engaging portion 21e is released. Accordingly, the latch 21 is biased by the latch biasing spring 22 to press the striker 3 by the inner wall of the engaging recessed portion 21a and rotates in the clockwise direction in FIG. 5 and FIG. 6. Then, the vehicle door 1 disengages the striker 3 at the engaging recessed portion 21a to become openable.

Meanwhile, the inside door handle 5 is operated to open the door, the operational force is transmitted to the inside open lever 16. Thus, the inside open lever 16 rotates in the counterclockwise direction about the rotational axis 0 in FIG. 4 to raise the end portion 16a and the flange 14a of the open link 14 is pressed by the end portion 16a from the lower side. Thus, the open link 14 is raised and the pawl 24 rotates with the liver lever 15 in the form described above. Therefore, the vehicle door 1 disengages the striker 3 at the engaging recessed portion 21a to become openable in a similar manner. Even when the inside open lever 16 rotates, the open link 14 is raised. This allows the open lever 12 to rotate to raise the end portion 12b.

Next, in the state that the vehicle door 1 is in the half closed state and the latch mechanism 20 is in the half latched state illustrated in FIG. 5, when either the door handle 4 or the door handle 5 is not operated to open the door, and the ring gear 55 is unrotatably engaged (refer to FIG. 8 (a)) by the engagement between the engaging detents 58 and the gear side engaging detents 69b, the electrical motor 47 is driven and the rotational power in one direction (the clockwise direction in FIG. 8) is transmitted to the sun gear 51 (the worm wheel portion 54), and the carrier 60 (the output shaft 49) outputs the rotational power in one direction (the clockwise direction in FIG. 8) in the form described above. In response to the output, the driving lever 62 rotates in the counterclockwise direction in FIG. 7, and the driving wire 36 is pulled from the end portion 35b and pulled into the end portion 35a illustrated in FIG. 5. Therefore, the operational lever 31 rotates in the clockwise direction in FIG. 5, and the striker 3, which engages at the engaging recessed portion 21a in the form described above, is pulled resulting in the full latched state of the latch mechanism 20. Thus, the vehicle door 1 is operated to close the door from the half closed state to the full closed state.

After the operation of the vehicle door has been completed and the vehicle door is in the closed state, the electric motor 47 is driven reversely so that the driving lever 62, which unitary rotates with the output shaft 49 (the carrier 60), rotates in the clockwise direction in FIG. 7. At this time, the electric motor is driven under low load, and the ring gear 55 can be unrotatably engaged with the cancel gear 69 with smaller power. The operational lever 31 is biased by the lever biasing spring and rotates in the counterclockwise direction in FIG. 6 pulling the driving wire 36 from the end portion 35a to return to or be held (return to the initial state) at the predetermined rotational position wherein the rotation is restricted by the lever stopper 32.

Meanwhile, when either the door handle 4 or the door handle 5 is operated to open the vehicle door 1 while the electrical motor 47 is driving, namely, the vehicle door 1 is in the closing operation, the oven lever 12 rotates about the first rotational axis 01 to raise the end portion 12b by the transmission of the operational force. Thus, the cam portion 76a is pressed and slidably contacted by the contact surface of the end portion 12b and the cancel lever 76 rotates in the clockwise direction in FIG. 3 about the second rotational axis 02 to raise the mounting strip 76b. In response to the movement, the wire 73 is pulled from the end portion 72b and pulled into the end portion 72a illustrated in FIG. 7. Therefore, the cancel lever 66 rotates unitary with the lever 70 in the clockwise direction in FIG. 8, and the gear side engaging detents 69b of the cancel gear 69 disengages the engaging detents 58 of the ring gear 55 to make the ring gear 55 rotatable in the form described above. Consequently, the output of the rotational force from the carrier 60 (the output shaft 49) is stopped. It is obvious that the latch mechanism 20 can be put into the unlatched state by operating the door handle 4 or the door handle 5 to open the door. In this situation, the operation lever 31, which engages with the latch 21 (the projecting follower portion 21f) to switch the latch mechanism 20 from the half latched state to the full latched state, allows the latch mechanism 20 to enter the unlatched state because the transmission of the power using the planet gear mechanism is blocked. As a result, the vehicle door 1 becomes openable.

Further, in this state, when the operational force of the door handle 4 or the door handle 5 is released, the cancel lever 66 is biased by the lever biasing spring 67 to return the predetermined rotational position and the cancel gear 69 moves along the guide groove 45b in a way that the gear side engaging detents 69b mesh the engaging de-tents 58 of the ring gear 55, and the ring gear 55 is unrotatably engaged again. Additionally, in response to the rotation of the cancel lever 66, the lever 70 rotates in the clockwise direction in FIG. 7, the wire 73 is pulled from the end portion 72a and pulled into the end portion 72b illustrated in FIG. 3 and the cancel lever 76 rotates in the counter clockwise direction in FIG. 3. Accordingly, the cancel lever 76 returns to or is held at the predetermined rotational position wherein the cam portion 76a is engaged with the end portion 12b of the open lever 12.

As described above in detail, according to the embodiment, the following effect can be achieved.

(1) In the embodiment, the cancel lever 76 engages with the open lever 21 at the cam portion 76a. The cancel lever 76 rotates in one direction about the second rotational axis 02 in response to the rotation of the open lever 12 about the first rotational axis 01 to block the transmission of the driving force from the actuator 40 to the latch mechanism 20. In the situation, the rotational distance (stroke) of the cancel lever 76 is adjusted (increased) relative to the rotational distance of the open lever 12 with the distance of the eccentricity between the first rotational axis 01 and the second rotational axis 02. With a very simple structure wherein the first rotational axis 01 is eccentrically disposed relative to the second rotational axis 02, the rotational distance for the cancel lever 76, which is necessary for blocking the transmission of the driving force from the actuator 40 to the latch mechanism 20, can be attained within an allowable rotational distance (stroke) of the open lever 12 to put the latch mechanism 20 into the unlatched state. Thus, the increase in the number of components and the increase of the production processes are restricted. As a result, the reduction in the costs for components and assemblies is achieved.

(2) In the embodiment, the open lever 12 is rotatably supported around the first axial portion 77a of the snap 77 to rotate the first rotational axis 01, and the cancel lever 76 is rotatably supported around the second axial portion 77b of the snap 77 to rotate the second rotational axis 02. Thus, with a very simple structure which is provided with the snap 77, the open lever 12 and the cancel lever 76 can rotate about each rotational axis (the first rotational axis 01 and the second rotational axis 02).

(3) In the embodiment, the cancel lever 76 can engage with the open lever 12 with a simple form which has only the cam portion 76a, which is made of a plate material, pressed by the open lever 12.

(4) In the embodiment, the rotational distance (stroke) which is necessary for the cancel lever 76 can be secured by increasing the width of the rotational distance of the open lever 12 without extending the rotational distance (stroke) of the open lever 12. Thus, the accommodation capacity within the vehicle door 1, where a space is limited, is improved. Particularly, in the vehicle width direction, where the space is extremely limited, the device satisfies both of securing the rotational distance (stroke) for the cancel lever 76 and the accommodation capacity.

The embodiment described above may be changed as follows. In the embodiment, the snap 77 is employed to rotate the open lever 12 and the cancel lever 76 about respective rotational axes. However, a structure of eccentric cam may be used alternatively.

In the embodiment, an engaging pin functioning in the same manner as the cam portion 76a may be projected in the cancel lever 76 to engage with the open lever 12. In the embodiment, the rotational distance (stroke) of the cancel lever 76 may be adjusted to be shortened based on the predetermined rotational distance allowed by the open lever 12.

1. A door closing apparatus comprising:
a latch mechanism operated for opening or closing a door of a vehicle, the latch mechanism being at a half latched state at a time that the door is half closed, the latch mechanism being at a full latched state at a time that the door is fully closed, and the latch mechanism being at an unlatched state at a time that the door is open;
a driving mechanism transmitting a driving force to the latch mechanism to operate the latch mechanism;
a first lever rotatably disposed about a first rotational axis and rotating in one direction about the first rotational axis in response to transmission of an operation force of a door handle to the first lever so that the latch mechanism is controlled at the unlatched state;
a second lever having an engaging portion which engages with the first lever and rotatably disposed about a second rotational axis being different from the first rotational axis, the second lever rotating in the one direction about the second rotational axis in response to a rotation in the one direction of the first lever to interrupt transmission of the driving force from the driving mechanism to the latch mechanism.

2. A door closing apparatus according to claim 1, further comprising a support member having a first axial portion and a second axial portion eccentrically arranged with the first axial portion, and the first lever and the second lever are rotatably supported about the first rotational axis and the second rotational axis, respectively.

3. A door closing apparatus according to claim 1, wherein the engaging portion is a cam plate portion pressed by the first lever in response to the rotation of the first lever in one direction about the first rotational axis.

4. A door closing apparatus according to claim 2, wherein the engaging portion is a cam plate portion pressed by the first lever in response to the rotation of the first lever in one direction about the first rotational axis.

5. A door closing apparatus according to claim 2, wherein the first axial portion is coaxially provided with the first rotation axis and the second axial portion is coaxially provided with the second rotation axis.

6. A door closing apparatus according to claim 1, wherein the support member includes a snap portion for press-fitting the first axial portion and the second axial portion.
